(19) United States
(12) Patent Application Publication
(10) Pub. No.: US 2010/0201866 A1
(43) Pub. Date: Aug. 12, 2010

(54) DIGITAL PHOTOGRAPHING APPARATUS WHICH SETS A SHUTTER SPEED ACCORDING TO A FREQUENCY OF AN ILLUMINATION APPARATUS

(75) Inventors: Jae-hyo Jung, Suwon-si (KR); Yong-gi Kim, Suwon-si (KR)

Correspondence Address: DRINKER BIDDLE & REATH LLP;ATTN: PATENT DOCKET DEPT., 191 N. WACKER DRIVE, SUITE 3700, CHICAGO, IL, 60606, US

(73) Assignee: Samsung Digital Imaging Co., Ltd., Suwon-si (KR)

(21) Appl. No.: 12/690,260

(22) Filed: Jan. 20, 2010

(30) Foreign Application Priority Data
Feb. 11, 2009 (KR) 10-2009-0011219

(51) Int. Cl. H04N 5/238; G03B 9/70

(52) U.S. Cl. 348/363; 396/166; 348/E05.04

(57) ABSTRACT

A digital photographing apparatus may include an imaging device which captures an image of a subject using an illumination apparatus that operates using alternating current (AC) power, and a shutter speed derivation unit which derives at least one shutter speed that is n/2 times a reciprocal of the frequency at which the illumination apparatus operates when the frequency at which the illumination apparatus operates is not n/2 times the frame rate of the imaging device, according to a result of comparing the frequency at which the illumination apparatus operates and the frame rate of the imaging device. When using the digital photographing apparatus to photograph, frequency information of the illumination apparatus may be easily obtained and flicker may be prevented by using the frequency information to set the shutter speed.

### CROSS-REFERENCE TO RELATED PATENT APPLICATION

This application claims the priority benefit of Korean Patent Application No. 10-2009-0011219, filed on Feb. 11, 2009, in the Korean Intellectual Property Office, the disclosure of which is incorporated herein in its entirety by reference.

### BACKGROUND

1. Field of the Invention

The present invention relates to a digital photographing apparatus, and more particularly to a digital photographing apparatus including an imaging device that may photograph a subject using an illumination apparatus that operates using alternating current (AC) power, and that may prevent flicker when capturing an image of the subject by using a shutter speed set according to a frequency of the illumination apparatus.

2. Description of the Related Art

Generally, digital cameras or digital camcorders photograph a subject to form an image by using natural light or light emitted from an illumination apparatus. A fluorescent lamp, which typically operates using alternating current (AC) power, is an example of an illumination apparatus that may be used. When the frequency at which a fluorescent lamp operates is not synchronized to the frame rate of an imaging device, flicker may occur on an image captured by the imaging device.

AC power is supplied at different frequencies in different countries. For example, AC power is typically supplied at a frequency of 60 Hz in Korea and in the USA, and at a frequency of 50 Hz in Japan and in China. Thus, when a digital camera or camcorder including an imaging device having a predetermined frame rate is used in different countries to photograph a subject to form an image, the frame rate of the digital camera or camcorder may not be synchronized to the frequency at which a fluorescent lamp providing light used by the digital camera or camcorder operates. Therefore, flicker may occur on the image of the subject. For example, when an aperture (i.e., stop), a sensitivity of an imaging device, a shutter speed, or the like is controlled in order to obtain the appropriate brightness of an image without regards to the country in which the camera or camcorder is being used in a typical manner, flicker may occur.

### SUMMARY

An exemplary digital photographing apparatus may easily obtain frequency information of an illumination apparatus used during photography by the digital photographing apparatus and may prevent flicker by using the frequency information.

An exemplary digital photographing apparatus may comprise an imaging device which captures an image of a subject illuminated by an illumination apparatus that operates using alternating current (AC) power, a determination unit which compares a frequency at which the illumination apparatus operates and a frame rate of the imaging device, and a shutter speed derivation unit which determines at least one shutter speed that is n/2 times a reciprocal of the frequency at which the illumination apparatus operates when the frequency at which the illumination apparatus operates is not n/2 times the frame rate of the imaging device, according to a determination result of the determination unit.

The digital photographing apparatus may further include a frequency derivation unit which derives the frequency at which the illumination apparatus operates, which frequency corresponds to a region where the digital photographing apparatus is located, from a database having at least one frequency corresponding to a region where an illumination apparatus operates.

The digital photographing apparatus may further include a location detecting unit which detects the region where the digital photographing apparatus is located, wherein the frequency derivation unit may derive the frequency at which the illumination apparatus operates, which frequency corresponds to the region detected by the location detecting unit.

The digital photographing apparatus may further include an operating unit which sets a region, wherein the frequency derivation unit may derive the frequency at which the illumination apparatus operates, which frequency corresponds to the region set through the operating unit. Language and time to be used may be set so as to set a region corresponding to the language and time to be used.

The digital photographing apparatus may further include a communication unit which receives region information corresponding to where the digital photographing apparatus is located, wherein the frequency derivation unit may derive the frequency at which the illumination apparatus operates, which frequency corresponds to a region corresponding to the region information received through the communication unit.

The digital photographing apparatus may further include a frequency detecting unit which detects the frequency at which the illumination apparatus operates.

An exemplary method of controlling a digital photographing apparatus comprising an imaging device which photographs a subject using an illumination apparatus that operates using alternating current (AC) power, and which captures an image of the subject, includes comparing a frequency at which the illumination apparatus operates and a frame rate of the imaging device, and deriving at least one shutter speed that is n/2 times a reciprocal of the frequency at which the illumination apparatus operates when the frequency at which the illumination apparatus operates is not n/2 times the frame rate of the imaging device, according to a result of the comparing.

The method may further include deriving the frequency at which the illumination apparatus operates, which frequency corresponds to a region where the digital photographing apparatus is located, from a database having at least one frequency corresponding to a region where an illumination apparatus operates.

The method may further include detecting the region where the digital photographing apparatus is located, wherein the frequency at which the illumination apparatus operates, which frequency corresponds to the region detected, may be derived.

The method may further include setting a region, wherein the frequency at which the illumination apparatus operates, which frequency corresponds to the region set, may be derived.

The method may further include setting language and time to be used, wherein a region corresponding to the language and time to be used may be set.

The method may further include receiving region information corresponding to where the digital photographing apparatus is located, wherein the frequency at which the illumination apparatus operates, which frequency corresponds to the region information received, may be derived.

### BRIEF DESCRIPTION OF THE DRAWINGS

The above and other features and advantages of the present invention will become more apparent by describing in detail exemplary embodiments thereof with reference to the attached drawings listed below:

FIG. 1 is a block diagram of an exemplary digital camera.

FIG. 2 is a block diagram of an exemplary controlling unit of the digital camera of FIG. 1.

FIGS. 3 through 6 are graphs showing exemplary cases where flicker occurs or does not occur, in order to explain prevention of flicker in an exemplary digital photographing apparatus.

FIG. 7 is a flow chart of an exemplary method of controlling a digital photographing apparatus, such as a digital camera.

### DETAILED DESCRIPTION

Hereinafter, a digital camera as an exemplary digital photographing apparatus will be described with regard to exemplary embodiments of the invention. However, the exemplary digital photographing apparatus is not limited to a digital camera. For example, the exemplary digital photographing apparatus may include another digital apparatus, such as a camera phone, a personal digital assistant (PDA), or a portable multimedia player (PMP), which may display an image on which flicker may occur due to a frequency at which an illumination apparatus operates.

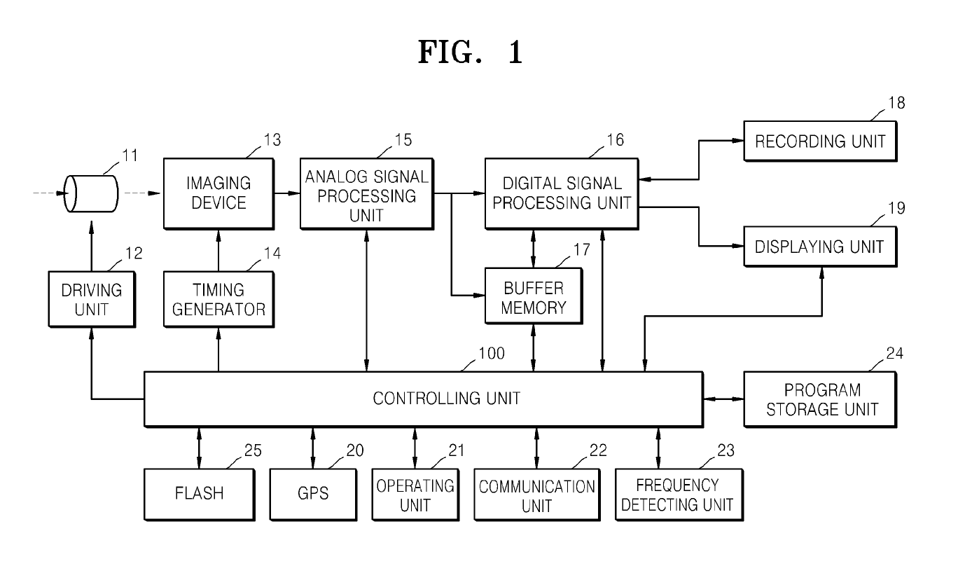

FIG. 1 is a block diagram of an exemplary digital camera. The digital camera may include an optical unit 11 through which an optical signal from a subject may be input, a driving unit 12 which drives the optical unit 11, an imaging device 13 which converts the optical signal input through the optical unit 11 into an electric signal, a timing generator 14 which provides a vertical synchronizing signal to the imaging device 13, and an analog signal processing unit 15 which receives the electric signal synchronized to the vertical synchronizing signal in order to correspond to a single frame image from the imaging device 13. The analog signal processing unit 15 may perform signal processing with respect to the electric signal and convert the electric signal into a digital signal. The signal processing may include performing noise reduction with respect to the electric signal, for example. In addition, the digital camera may include a digital signal processing unit 16 which performs image signal processing with respect to image data provided from the analog signal processing unit 15. The image data may be input to the digital signal processing unit 16 in real time. Alternatively, the image data may be temporarily stored in a buffer memory 17, and then may be input to the digital signal processing unit 16 when needed for performing the image signal processing. The digital camera may also include a recording unit 18 in which image data and predetermined information may be recorded, and a displaying unit 19 which may display an image. The digital camera may include at least one of each of a global positioning system (GPS) 20 which detects a location of the digital camera, an operating unit 21 through which a user's manipulation may be input, a communication unit 22 which may transmit and receive information to and from an external server or a terminal, and a frequency detecting unit 23 which may detect a frequency at which an illumination apparatus which provides illumination for the digital camera operates. The digital camera may further include a program storage unit 24 in which a program related to an operation of the digital camera may be stored, and a flash 25 that may provide light for illuminating a subject. In addition, the digital camera may include a controlling unit 100 which may control any or all elements of the digital camera according to user's manipulation or input images.

Elements of the digital camera will now be described in more detail below.

The optical unit 11 may include a lens which concentrates an optical signal (e.g., light from an illuminated subject to be photographed), a stop (i.e., aperture which adjusts an amount of the optical signal to be passed through the optical unit 11, and a shutter which controls input of the optical signal to the imaging device 13. The lens may include a zoom lens which controls a viewing angle so as to be narrowed or widened by adjusting a focal length of the lens, and a focus lens which focuses on a subject. The zoom lens and the focus lens may each include a single lens, or alternatively, may include a group of a plurality of lenses. A mechanical shutter having a cover that may open or close, such as in up and down directions, may be used as the shutter. Alternatively, instead of having a separate shutter, the optical unit 11 may function as a shutter by controlling electric signals input to the imaging device 13.

The driving unit 12 may control the optical unit 11 by driving the lenses into positions, opening and shutting the stop, and controlling operations of the shutter, in order to perform operations such as auto focus, auto exposure control (APSC), stop control, zooming, and focus change. The driving unit 12 may receive a control signal from the controlling unit 100, and then may control the driving of the optical unit 11 in response thereto.

The imaging device 13 may receive the optical signal input through the optical unit 11, and then capture an image of a subject. Examples of the imaging device 13 may include a complementary metal oxide semiconductor (CMOS) sensor array, or a charge coupled device (CCD) sensor array.

The electric signal provided by the imaging device 13 may include an analog signal, so the analog signal processing unit 15 may include an A/D converter which digitizes the electric signal to form image data. In addition, the analog signal processing unit 15 may include a circuit performing signal processing, e.g., gain adjusting, or waveform standardization with respect to the electric signal provided by the imaging device 13.

The digital signal processing unit 16 may perform image signal processing for improving image quality, such as noise reduction, gamma correction, color filter array interpolation, color matrix, color correction, or color enhancement, with respect to image data input to the digital signal processing unit 16. In addition, the digital signal processing unit 16 may generate an image file by compressing the image data generated by performing the image signal processing for improving image quality, or may restore the image data from the image file. A compression format of the image data may be reversible (e.g., lossless) or irreversible (e.g., lossy). Examples of the compression format may include joint photographic experts group (JPEG), and JPEG 2000. The image file may be recorded in the recording unit 18. The digital signal processing unit 16 may functionally perform distinction processing, color processing, blur processing, edge emphasis processing, image analysis processing, image recognition processing, image effect processing, and the like. The image recognition processing may include face recognition processing, scene recognition processing, and the like. In addition, the digital signal processing unit 16 may perform image signal processing for displaying an image on the displaying unit 19, and for example, may perform brightness level adjustment, color calibration, contrast adjustment, contour emphasis adjustment, and split screen processing, may generate character images, and may synthesize images. The digital signal processing unit 16 may be connected to an external monitor and perform predetermined image signal processing in order to display an image corresponding to the image data on the external monitor, may transmit the image data to the external monitor, and then may control the external monitor so as to display the image corresponding to the image data on the external monitor.

The image data transmitted from the analog signal processing unit 15 may be transmitted to the digital signal processing unit 16 in real time. When image data transmission speed and calculation speed of the digital signal processing unit 16 are different, the image data may be temporarily stored in the buffer memory 17, and then may be provided to the digital signal processing unit 16. Examples of the buffer memory 17 may include a memory device such as a synchronous dynamic random access memory (SDRAM), multi chip package (MCP), or a dynamic random access memory (DRAM).

The image data to which the predetermined image signal processing is performed in the digital signal processing unit 16 may be recorded in the recording unit 18, or alternatively, may be transmitted to the displaying unit 19 to be displayed as a predetermined image. Examples of the recording unit 18 may include SD card/MMC, a hard disk drive (HDD), an optical disk, an optical magnetic disk, or a hologram memory. In addition, examples of the displaying unit 19 may include a display device such as a liquid crystal display device (LCD), an organic light emitting diode (OLED), a plasma display panel (PDP), or an electrophoresis display device (EDD).

The GPS 20 may detect a location by using a satellite, and may detect a location of the digital camera.

The operating unit 21 may include a member for user's manipulation of the digital camera or for setting various settings when using the digital camera. For example, the operating unit 21 may include a button, a key, a touch panel, a touch screen, a dial, or the like. In addition, through the operating unit 21, a user operating signal, such as power on/off, photographing start/stop, reproduction start/search, optical system driving, mode conversion, or selection manipulation, may be input. For example, the operating unit 21 may include a member for setting language and time, and a member for setting a region and a country.

The communication unit 22 may transmit and receive predetermined information to and from an external server or a terminal by using a communicating manner such as radio frequency identification (RFID), or a wireless networking technology (e.g., WIFI). In the present embodiment illustrated in FIG. 1, the communication unit 22 may receive frequency information corresponding to the region in which the illumination apparatus providing illumination used by the digital camera operates. For example, when the digital camera is used in Korea, the communication unit 22 may receive frequency information corresponding to the AC power frequency in Korea, that is, frequency information corresponding to a frequency of 60 Hz from a server located in Korea.

The frequency detecting unit 23 may detect frequency information of an illumination apparatus by analyzing wave patterns shown on a plurality of input images. For example, when wave patterns are not shown, a frequency obtained from the frequency information of the illumination apparatus may be seen to be n/2 times the frame rate of the imaging device 13.

The program storage unit 24 may store an operating system (OS), and an application program, which are used to operate the digital camera. Examples of the program storage unit 24 may include an erasable programmable read only memory (e.g., E2PROM), a flash memory, or a read only memory (ROM).

The flash 25 may check exposure information of an input image. Then, if determined to be necessary, the flash 25 may operate automatically, or alternatively, may be operated manually by a user's manipulation. The flash 25 may include an element providing light used by the digital camera in order to compensate for underexposure or to achieve special effects.

The controlling unit 100 may control any or each element of the digital camera according to the application program, and may control the elements according to user's manipulation, input images, image processing results of the digital signal processing unit 16, and the like.

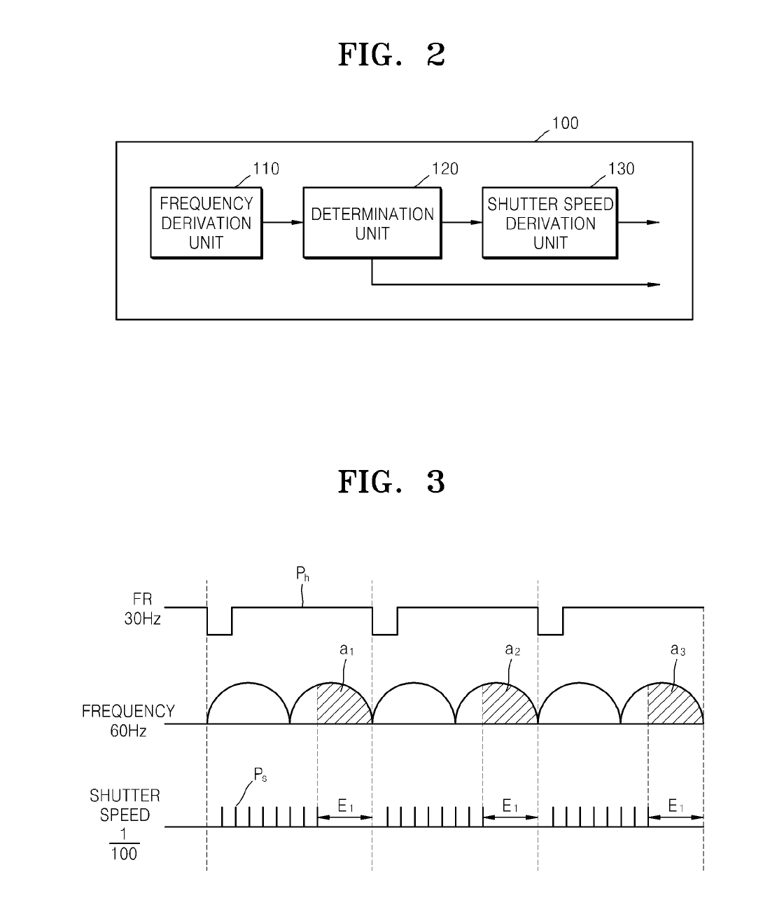

FIG. 2 is a block diagram of an exemplary controlling unit 100 of the digital camera of FIG. 1. The controlling unit 100, which may be configured for preventing flicker, will be described in more detail with reference to FIG. 2. The controlling unit 100 may include a frequency derivation unit 110, a determination unit 120, and a shutter speed derivation unit 130.

According to an embodiment, the GPS 20 detects the location of a digital camera, generates location information, and then provides the location information to the frequency derivation unit 110. Then, the frequency derivation unit 110 may derive the frequency at which the illumination apparatus operates from the location information. For example, a database of at least one of frequency corresponding to regions in which an illumination apparatus operates may be previously stored, and the frequency derivation unit 110 may derive the frequency corresponding to the location information from the database of the at least one of frequency corresponding to a region where an illumination apparatus operates stored in the database. The illumination apparatus may operate using alternating current (AC) power. In the presence of a database of AC powers provided to the location or the region containing the location, the frequency of the AC power supplied may be derived from the database of AC powers.

According to another embodiment, when a user sets at least one of each of a language to be used and a country time, a location, a region, and the like on the digital camera through the operating unit 21, the frequency derivation unit 110 may derive the frequency at which the illumination apparatus operates or a frequency of AC power supplied, which corresponds to the language and time to be used, and the location or the region containing the location, from the database of at least one of frequency corresponding to a region where an illumination apparatus operates or the database of AC powers.

According to another embodiment, information regarding the frequency at which the illumination apparatus operates or the frequency of AC power supplied is received through the communication unit 22 from an external server or a terminal, and then the frequency derivation unit 110 receives the frequency information provided by the communication unit 22 so as to set the frequency at which the illumination apparatus operates.

Then, the determination unit 120 may determine whether the frequency corresponding to a region where the illumination apparatus operates, obtained as described above, is n/2 times the frame rate (FR) of the imaging device 13, where n is a natural number, and which may be represented as Equation 1 below.

$$FREQUENCY ( Hz ) = FR ( fps ) \times \frac{n}{2} ( n = NATURAL NUMBER ) \qquad ( 1 )$$

According to a result of the determination of the determination unit 120, when the frequency corresponding to the region where the illumination apparatus operates is not n/2 times the frame rate of the imaging device 13, a first control signal corresponding to this case may be transmitted to the shutter speed derivation unit 130. In addition, the shutter speed derivation unit 130 may derive at least one shutter speed that is n/2 times the inverse of the frequency. A method of deriving shutter speeds corresponding to the frame rate of the image device 13 and according to the frequency corresponding to the region where the illumination apparatus operates may be represented by Equation 2 below.

$$SHUTTER SPEED = \frac{1}{FREQUENCY ( Hz )} \times \frac{n}{2} \\ ( n = NATURAL NUMBER ) \qquad ( 2 )$$

The controlling unit 100 may display the shutter speeds derived on the displaying unit 19 and may guide a user to set any one of the shutter speeds. Alternatively, the controlling unit 100 may select at least one shutter speed appropriate for the current photographing state so as to automatically set the shutter speed.

On the other hand, when the determination unit 120 determines that the frequency corresponding to the region where the illumination apparatus operates is n/2 times the frame rate of the imaging device 13, the determination unit 120 may output a second control signal corresponding to this case. A predetermined shutter speed may be set according to the second control signal or user's input. Alternatively, a shutter speed that is previously set may be maintained.

FIGS. 3 through 6 are graphs showing exemplary cases where flicker occurs or does not occur, in order to explain prevention of flicker in an exemplary digital photographing apparatus. A principle that may prevent flicker by using the frame rate of the imaging device 13, the frequency at which the illumination apparatus operates, and the shutter speed will be described with reference to FIGS. 3 through 6.

FIG. 3 is a graph showing a case where the frame rate of an imaging device is 30 Hz, the frequency at which the illumination apparatus operates is 60 Hz, and the shutter speed is 1/100th of a second. The frequency at which the illumination apparatus operates may be determined according to the frequency of input AC power. Thus, the frequency of the AC power input to the illumination apparatus is 60 Hz.

When the frequency of a vertical synchronizing signal Ph input to a progressive type imaging device is 30 Hz, the vertical synchronizing signal Ph is input for each respective frame at 1/30th of a second. Since in this case the frequency at which the illumination apparatus operates is 4/2 times the frame rate, a signal having 2 periods is input for each respective frame. Thus, the exposure amount for each respective frame may be the same at a predetermined shutter speed. The shutter speed corresponds to the exposure time E1 from the last shutter pulse Ps to an end point of a frame. The exposure amount may correspond to the amount of light that is incident for the exposure time. When other parameters are neglected, since the amount of light is the same for each respective frame, exposure amounts of light a1, a2, and a3 are exposed for the same amount of exposure time for each respective frame in the illumination apparatus. Note that the vertical synchronizing signal Ph, the graph of the amount of light of the illumination apparatus operating at the frequency 60 Hz, the shutter pulses Ps, and the exposure time E1 may not be drawn to scale, but merely as examples to illustrate the concepts presented herein.

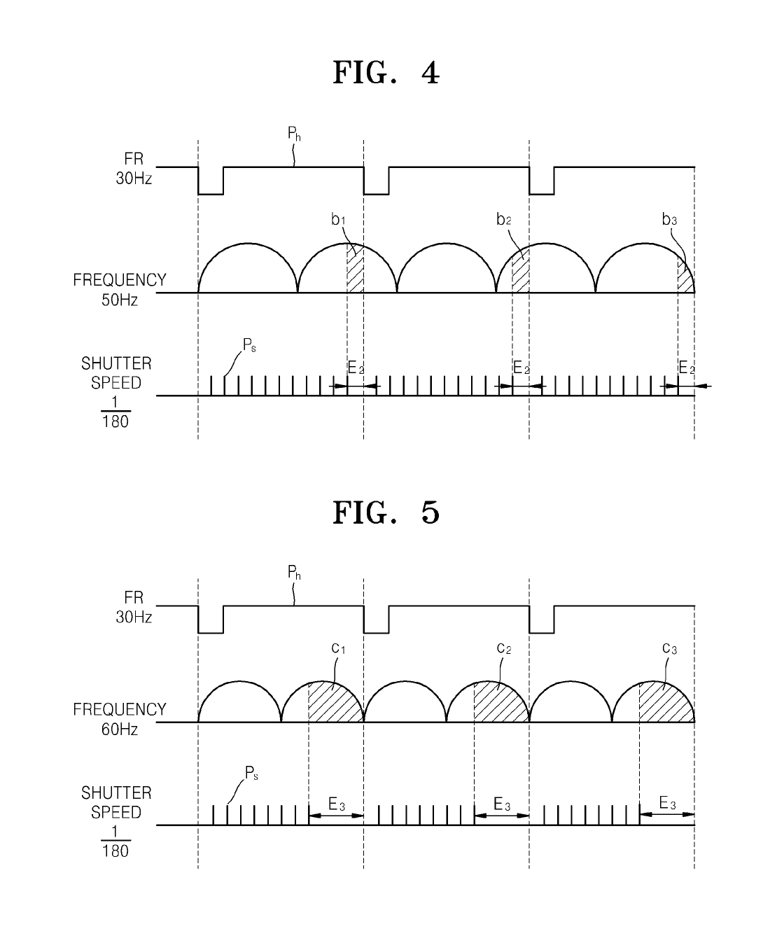

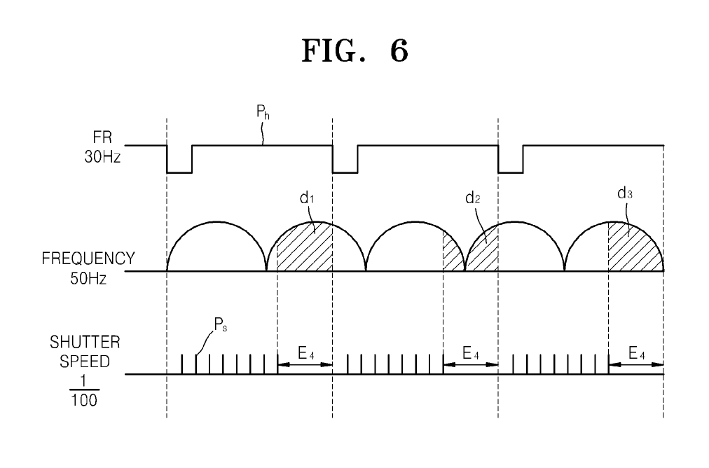

FIG. 4 is a graph showing a case where the frame rate of an imaging device is 30 Hz, the frequency at which an illumination apparatus operates is 50 Hz, and the shutter speed is 1/180th of a second. Referring to FIG. 4, since the frequency at which the illumination apparatus operates is not n/2 times the frame rate of the imaging device, the amount of light that is incident for the exposure time E2 may be different for each respective frame. Thus, exposure amounts of light b1, b2, and b3 input for an exposure time of 1/180 seconds for each respective frame may be different from each other. In this case, flicker may occur, and thus flicker may be prevented by setting the shutter speed to a speed that is a natural number divided by two multiple of the frequency at which the illumination apparatus operates, according to a method of controlling a digital photographing apparatus. An example of this method will be described in more detail with reference to FIG. 6. Note that the vertical synchronizing signal Ph, the graph of the amount of light of the illumination apparatus operating at the frequency 50 Hz, the shutter pulses Ps, and the exposure time E2 may not be drawn to scale, but merely as examples to illustrate the concepts presented herein.

FIG. 5 is a graph showing a case where the frame rate of an imaging device is 30 Hz, the frequency at which an illumination apparatus operates is 60 Hz, and the shutter speed is 1/180th of a second. Referring to FIG. 5, since the frequency at which the illumination apparatus operates is a multiple of the frame rate, exposure amounts c1, c2, and c3 are the same at a shutter speed of 1/180 seconds. Thus, flicker does not occur. Note that the vertical synchronizing signal Ph, the graph of the amount of light of the illumination apparatus operating at the frequency 60 Hz, the shutter pulses Ps, and the exposure time E3 may not be drawn to scale, but merely as examples to illustrate the concepts presented herein.

FIG. 6 is a graph showing a case where the frame rate of an imaging device is 30 Hz, the frequency at which an illumination apparatus operates is 50 Hz, and the shutter speed is 1/100th of a second. Referring to FIG. 6, since the frequency at which the illumination apparatus operates is not a multiple of the frame rate, exposure amounts of light input for each respective frame are different from each other. Thus, flicker may be prevented by setting an exposure time corresponding to a multiple of the frequency at which the illumination apparatus operates. In FIG. 6, the shutter speed is set to 1/100th of a second, which is n/2 (n=1) times the reciprocal of the frequency of 50 Hz. Thus, exposure amounts d1, d2, and d3 of light input for an exposure time E4 for each respective frame are the same. Note that the vertical synchronizing signal Ph, the graph of the amount of light of the illumination apparatus operating at the frequency 50 Hz, the shutter pulses Ps, and the exposure time E4 may not be drawn to scale, but merely as examples to illustrate the concepts presented herein.

Thus, flicker may be prevented by controlling the shutter speed of an imaging device according to the frequency of AC power provided to an illumination apparatus, corresponding to location information obtained by a GPS, a language to be used, or a country time, which may be set by a user through an operating unit. In addition, the frequency of AC power supplied may be obtained by a frequency detection unit, a communication unit, or the like.

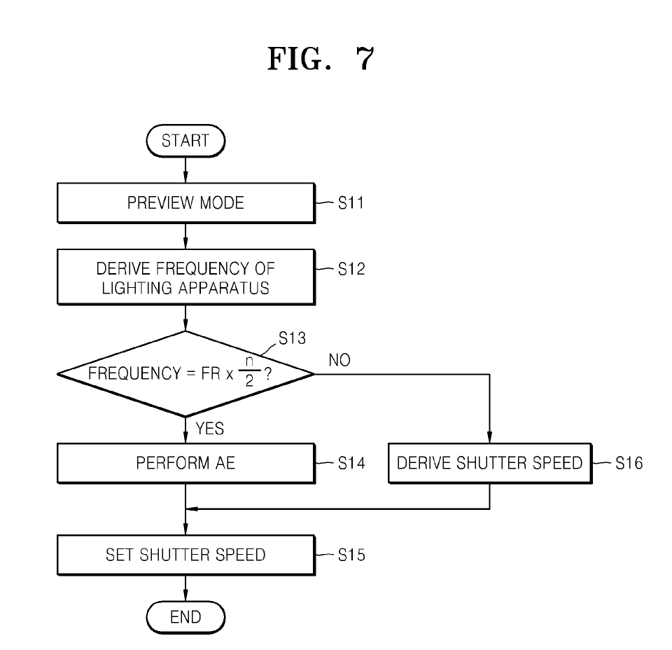

FIG. 7 is a flow chart of an exemplary method of controlling a digital photographing apparatus, such as a digital camera. In an operation S11, a preview mode may be performed in the digital camera. During the preview mode, an image may be input in real time, and may be displayed on a displaying unit.

In the preview mode, in an operation S12, a frequency at which an illumination apparatus operates is derived. The illumination apparatus may illuminate a subject photographed by the digital camera. The frequency at which the illumination apparatus operates may be derived by deriving the frequency of AC power provided corresponding to the region in which the digital camera is located by using a GPS, a frequency detection unit, a communication unit, an operation unit, or the like as described above. The frequency at which the illumination apparatus operates may be derived at a predetermined point of time during the preview mode. Alternatively, the frequency at which the illumination apparatus operates may be derived at an appropriate point of time prior to using the digital camera to photograph, such as when a first shutter-release signal is input by half-pressing a shutter button, in order to prevent waste of power consumption. A determination operation and a shutter speed derivation operation may be performed while the shutter button is half-pressed.

In an operation S13, a determination may be made as to whether the derived frequency is n/2 times the frame rate of an imaging device included in the digital camera.

When the derived frequency is determined to be n/2 times the frame rate of the imaging device in the operation S13, an automatic exposure (AE) may be performed and the shutter speed of the digital camera may be derived in operation S14.

On the other hand, when the derived frequency is determined to not be n/2 times the frame rate of the imaging device in the operation S13, at least one shutter speed that is n/2 times the reciprocal of the frequency may be derived in an operation S16. Then, in operation S15, any one of the shutter speeds derived may be set automatically or by a user's manipulation. When the shutter speed is set by the user's manipulation, any one of the shutter speeds derived may be selected by another operating button while the shutter button is half-pressed.

Although not illustrated in FIG. 7, the method of controlling the photographing apparatus may further include photographing an image of a subject when a second shutter-release signal is input by setting a predetermined shutter speed for preventing flicker while the shutter button is half-pressed and then completely pressing the shutter button.

According to embodiments of the present invention, the frequency information at which an illumination apparatus used during the photography by a digital photographing apparatus may be easily obtained. In addition, flicker may be prevented by setting an appropriate shutter speed according to the frequency information or by guiding a user.

A program for executing a method as described herein may be stored in a computer readable storage medium. The program may include instructions (e.g., code) executable by a processor such as the controlling unit 100. The computer readable storage medium may include the program storage unit 24, the recording unit 18, the buffer memory 17, or any data storage device that may store data which may thereafter be read by a computer system. The computer readable storage medium may include memory implemented in an integrated circuit (e.g., random access memory (RAM), read-only memory (ROM), erasable programmable read only memory (EPROM), static RAM (SRAM), or flash memory), a magnetic storage medium (e.g., floppy disk, hard disk, magnetic tapes), an optical storage medium (e.g., compact disc (CD or CD-ROM) or digital versatile disc (DVD or DVD-ROM)), or carrier waves (such as data transmission through the Internet). The computer readable storage medium may also be distributed over network coupled computer systems so that the computer readable instructions are stored and executed in a distributed fashion. Also, functional programs, code, and code segments for accomplishing embodiments of the present invention may be construed by programmers skilled in the art to which the present invention pertains without undue experimentation.

The embodiments discussed herein are illustrative of the present invention. As these embodiments of the present invention are described with reference to illustrations, various modifications or adaptations of the methods and or specific structures described may become apparent to those skilled in the art. All such modifications, adaptations, or variations that rely upon the teachings of the present invention, and through which these teachings have advanced the art, are considered to be within the spirit and scope of the present invention. Hence, these descriptions and drawings should not be considered in a limiting sense, as it is understood that the present invention is in no way limited to only the embodiments illustrated. It will be recognized that the terms “comprising,” “including,” and “having,” as used herein, are specifically intended to be read as open-ended terms of art.

What is claimed is:

1. A digital photographing apparatus comprising:
an imaging device which captures an image of a subject illuminated by an illumination apparatus that operates using alternating current (AC) power;
a determination unit which compares a frequency at which the illumination apparatus operates and a frame rate of the imaging device; and
a shutter speed derivation unit which determines at least one shutter speed that is n/2 times a reciprocal of the frequency at which the illumination apparatus operates when the frequency at which the illumination apparatus operates is not n/2 times the frame rate of the imaging device, according to a determination result of the determination unit.

2. The digital photographing apparatus of claim 1, further comprising a frequency derivation unit which derives the frequency at which the illumination apparatus operates, which frequency corresponds to a region where the digital photographing apparatus is located, from a database having at least one frequency corresponding to a region where an illumination apparatus operates.

3. The digital photographing apparatus of claim 2, further comprising a location detecting unit which detects the region where the digital photographing apparatus is located,
wherein the frequency derivation unit derives the frequency at which the illumination apparatus operates, which frequency corresponds to the region detected by the location detecting unit.

4. The digital photographing apparatus of claim 2, further comprising an operating unit which sets a region,
wherein the frequency derivation unit derives the frequency at which the illumination apparatus operates, which frequency corresponds to the region set through the operating unit.

5. The digital photographing apparatus of claim 4, wherein the operating unit sets language and time to be used so as to set a region corresponding to the language and time to be used.

6. The digital photographing apparatus of claim 2, further comprising a communication unit which receives region information corresponding to where the digital photographing apparatus is located,
wherein the frequency derivation unit derives the frequency at which the illumination apparatus operates, which frequency corresponds to a region corresponding to the region information received through the communication unit.

7. The digital photographing apparatus of claim 1, further comprising a frequency detecting unit which detects the frequency at which the illumination apparatus operates.

8. A method of controlling a digital photographing apparatus comprising an imaging device which photographs a subject using an illumination apparatus that operates using alternating current (AC) power, and which captures an image of the subject, the method comprising:
comparing a frequency at which the illumination apparatus operates and a frame rate of the imaging device; and
deriving at least one shutter speed that is n/2 times a reciprocal of the frequency at which the illumination apparatus operates when the frequency at which the illumination apparatus operates is not n/2 times the frame rate of the imaging device, according to a result of the comparing.

9. The method of claim 8, further comprising deriving the frequency at which the illumination apparatus operates, which frequency corresponds to a region where the digital photographing apparatus is located, from a database having at least one frequency corresponding to a region where an illumination apparatus operates.

10. The method of claim 8, further comprising detecting the region where the digital photographing apparatus is located,
wherein the frequency at which the illumination apparatus operates, which frequency corresponds to the region detected, is derived.

11. The method of claim 8, further comprising setting a region,
wherein the frequency at which the illumination apparatus operates, which frequency corresponds to the region set, is derived.

12. The method of claim 11, further comprising setting language and time to be used,
wherein a region corresponding to the language and time to be used is set.

13. The method of claim 8, further comprising receiving region information corresponding to where the digital photographing apparatus is located,
wherein the frequency at which the illumination apparatus operates, which frequency corresponds to the region information received, is derived.

14. The method of claim 8, further comprising detecting the frequency at which the illumination apparatus operates.

15. A computer readable storage medium having stored thereon a program executable by a processor for executing a method of controlling a digital photographing apparatus comprising an imaging device which photographs a subject using an illumination apparatus that operates using alternating current (AC) power, and which captures an image of the subject, the method comprising:
comparing a frequency at which the illumination apparatus operates and a frame rate of the imaging device; and
deriving at least one shutter speed that is n/2 times a reciprocal of the frequency at which the illumination apparatus operates when the frequency at which the illumination apparatus operates is not n/2 times the frame rate of the imaging device, according to a result of the comparing.

16. The computer readable storage medium of claim 15, wherein the method further comprises deriving the frequency at which the illumination apparatus operates, which frequency corresponds to a region where the digital photographing apparatus is located, from a database having at least one frequency corresponding to a region where an illumination apparatus operates.

17. The computer readable storage medium of claim 15, wherein the method further comprises detecting the region where the digital photographing apparatus is located,
wherein the frequency at which the illumination apparatus operates, which frequency corresponds to the region detected, is derived.

18. The computer readable storage medium of claim 15, wherein the method further comprises setting a region,
wherein the frequency at which the illumination apparatus operates, which frequency corresponds to the region set, is derived.

19. The computer readable storage medium of claim 15, wherein the method further comprises setting language and time to be used,
wherein a region corresponding to the language and time to be used is set.

20. The computer readable storage medium of claim 15, wherein the method further comprises receiving region information corresponding to where the digital photographing apparatus is located,
wherein the frequency at which the illumination apparatus operates, which frequency corresponds to the region information received, is derived.
